(19) United States
(12) Patent Application Publication
(10) Pub. No.: US 2016/0054839 A1
(43) Pub. Date: Feb. 25, 2016

(54) Interactive Object Contour Detection Algorithm for Touchscreens Application

(71) Applicant: ARTWARE, INC., Newton Center, MA (US)

(72) Inventor: Mordechai Arie Kintzlinger, Jerusalem (IL)

(21) Appl. No.: 14/781,515

(22) PCT Filed: Apr. 13, 2014
(86) PCT No.: PCT/US14/33904

§ 371 Date: Sep. 30, 2015

Related U.S. Application Data
(60) Provisional application No. 61/812,395, filed on Apr. 16, 2013.

(51) Int. Cl. G06F 3/041; G06T 7/00; G06F 3/0488; G06T 5/00; G06T 3/00; G06F 3/0354; G06T 11/60; G06T 7/40

(52) U.S. Cl. CPC G06F 3/0412; G06T 11/60; G06T 7/0083; G06T 7/40; G06T 5/004; G06T 3/0093; G06F 3/03545; G06F 3/03543; G06F 3/04883; G06T 2207/20144; G06T 2207/20036; G06T 2211/424

(57) ABSTRACT

In a method for use in an apparatus displaying an image, an object in the image at least partially marked by a mask is highlighted. Successive selection points located on a line crossing a boundary of the mask represent a path input by a user using continuous movements and correspond to respective reference pixels in the image. An initial reference point where the line crosses the boundary is used as a seed point to successively change an attribute of successive points in the mask centered on the seed point for all mask points corresponding to image pixels surrounding the respective reference pixel and for each of which points the corresponding pixel attribute differs from that of the corresponding reference pixel in the image by no more than a predetermined threshold.

### FIELD OF THE INVENTION

The present invention relates to image capture and image processing, and more particularly to capturing and processing digital images using a mobile device.

### BACKGROUND OF THE INVENTION

The use of touchscreens has proliferated with the evolution of mobile devices such as smartphones and tablets. The touchscreen has many benefits where it eliminates the need for standard keyboard and mouse. However, there are disadvantages when it is used in mobile device without a mouse or keyboard where the figure is used as a cursor or pointer in applications where the need for a pointer having single pixel resolution is necessary. One such use relates to marking an object in a digital image on a touch screen for the purpose of isolating it from the rest of the image for further processing.

To illustrate the problem, consider use of a mobile device with screen resolution of 960 by 640 pixel at 326 DPI (Dots per Inch) in an application for isolating a foreground object from the background by converting it to a transparent or any other layer. The user is required to mark the contour of the object or mark all the inner surfaces of the object on a touch screen using his figure. Assuming the width of the average finger to be around 15 mm, this means that the finger may cover area of about 200 by 200 pixels square, which makes it almost impossible to mark a multi-segment object.

WO 2011/039684 discloses an apparatus for selecting a region of an image displayed on a smartphone including means for receiving input indicating a selection point; generating a set of paths originating from said selection point; determining an influence value for each point on a path to generate an influence map; and applying said influence map to an image. The influence value is the result of image editing such as tonal, brightness, contrast or color adjustment.

WO 2011/039684 is based on an algorithm developed by Lischinski et al. entitled “Interactive local manipulation of tonal values” presented at Proc. SIGGRAPH 2006 and appearing in ACM Transactions on Graphics, vol. 25, no. 3, July 2006 and in WO 2005/104662. The principle of operation relies on selecting an area of a pixelated image using a stroke or a scribble, typically made using a stylus, and using the color of the area thus selected to identify a contour within which to effect image enhancement. The image is typically displayed on a touchscreen of a smartphone and the area may be selected using a stylus or the user's finger.

U.S. Pat. No. 6,408,109 discloses a method and apparatus for edge detection in a digital image, even for edges that are not substantially parallel to the axes of the pixel grid, by exploiting computationally inexpensive estimates of gradient magnitude and direction.

It thus emerges that use of a finger to select a part of an image displayed on a touchscreen of a smartphone is known. However, the edges of the object are determined based on color proximity between adjacent pixels.

### SUMMARY OF THE INVENTION

An object of the present invention is to allow the user to isolate an object from a pixelated image displayed on a touchscreen using the finger based on an algorithm that is not based on color proximity between adjacent pixels and uses fewer resources.

To this end there is provided in accordance with the invention a method for iteratively modifying a display image using a mask layer having the features of the independent claims.

The algorithm according to one embodiment of the invention is based on implementing an efficient object segmental detection algorithm while sensing rough motion of the user's figure to determine the segments of the image that constitute the object. This allows the user to accurately isolate an object from an image displayed on a touchscreen using the finger. In one embodiment, this displays the selected object on a transparent background. The isolation is done by selecting the object with the finger, when the main idea is to simulate paint spilling from where the finger is touching and filling the object. At the first touch, the algorithm simulates the user spilling the paint from his finger for the first time. While moving the finger across the screen, the user simulates spreading the paint to additional areas, or while touching outside the painted area and moving the finger towards the paint split to clear it, the user simulates scooping back the paint that has already been spilled. In addition the user can place his finger in the same place and the painted area will grow and grow, as if the paint keeps on spilling.

According to the invention the algorithm operates in real time, enabling the paint to be spilled or scooped back while the user is moving his finger along the screen and makes it possible for the user to accurately mark an object without being forced to mark the entire object and reach exactly the boundaries, because of the inaccuracy of working with the finger or any other selection device.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a state diagram depicting user action;

FIG. 2 is a flow diagram depicting flood fill;

FIG. 3 shows pictorially the effect of touching the image with only a single thread;

FIGS. 4a to 4f are pictorial representations of the mask layer during successive iterations of the algorithm when constructing the mask;

FIGS. 5a to 5d are pictorial representations of the mask layer during successive iterations of the algorithm when clearing parts of the mask; and

FIG. 6 is a pictorial representation of the mask layer when creating holes.

### DETAILED DESCRIPTION OF EMBODIMENTS

In the following description of some embodiments, identical components that appear in more than one figure or that share similar functionality will be referenced by identical reference symbols.

### Interface

### General Description

We want to create a mask that is used to mark an object in displayed image that may then be processed as required. In one embodiment, those areas of the mask that overlap and thus define the contour of the object are painted. The mask may also contain areas that are not painted but are surrounded by painted areas and correspond to holes in the object.

The algorithm starts by identifying objects by their color and using the flood fill function (for example, the Intel® Open Source Computer Vision Library). “Flood fill” takes three inputs:

1. a row number, x

2. a column number, y

3. a (new) color d

The basic flood fill function starts by changing the color of the pixel at location (x, y) from its original color c to the new color d. Then, all neighboring pixels (i.e. those pixels to the left, right, above and below, of the pixel at (x, y)) whose color is also c will have their color changed to the new color d and the process continues on the neighbors of the changed pixels until there are no more pixel locations to consider. In the invention flood fill is activated only so long as the user maintains finger pressure with the touch screen or tablet. Furthermore, as will be explained in further detail below, the rate at which flood fill is implemented varies inversely according to the distance of the current pixel from the nominal center of the user's finger. This controls the rate at which color spreads and allows fine control and correction, particularly near edges or boundaries in the image.

The flood fill function operates as follows: the user touches a pixel; flood fill paints the neighbors of that pixel only if the difference between each three colors (RGB) is smaller than a limit defined in advance. The function compares the painted pixel to its unpainted neighbors. If the colors of those neighbors are close enough to the first painted pixel, they will also be painted and so on. This way, theoretically, when a certain pixel is selected, all neighboring pixels with the same color will be painted as well. This is distinct from known approaches where objects in an image are selected based on the color proximity of neighboring pixels.

From the moment a picture has a painted area the user can enlarge it by placing the finger inside that surface and moving it near the edge of the painted area or even outside of it. He can also make it smaller by touching outside the painted area and moving the finger towards the edge of the painted area or dragging the finger inside the painted area. The user can enlarge and reduce the painted area as long as he likes until the result is satisfactory and the wanted object is isolated.

Another way of enlarging the painted area is to place the finger in one spot and hold it still. Then the flood fill function is executed recursively at fixed time increments, each time with a slightly higher parameter so that the paint is progressively spilled as time goes by, the ‘parameter’ being the color difference Δ between the seed pixel and the current pixel. In other words, when pressure on the touchscreen remains uninterrupted, the sensitivity of the flood fill function is allowed to decrease so that the flood fill spreads more quickly. When the user sees that the painted area approaches the edges of the object he or she wishes to select, pressure on the touchscreen is removed momentarily and re-applied to restart the flood fill function using its default parameter so as to allow finer control as the flood fill reaches the boundary of the selected object.

In addition to the enlargement and reduction of the painted area, the user can also create “holes” in the object so as to create unpainted areas surrounded by painted areas. In accordance with some embodiments, this is done by first painting the area including the hole and then double pressing, which allows for painted pixels to be subsequently unpainted or ‘cleared’. This speeds processing, since an area can be filled rapidly such that small holes remaining inside the painted area will automatically be filled. This avoids the need to “chase” and fill every little hole created unintentionally while facilitating subsequent creation of holes where they are genuinely required. Once the mask is painted, any areas inside the mask can then be removed by creating an initial hole, which can then be expanded by clearing mask points in an analogous manner to their creation.

Since it is not possible to foresee the objects the user will want to select, the color differences between those objects and the surrounding area, or the color difference inside the selected object, the user is given the possibility to change the intensity levels of the paint and delete operations so as to adjust their sensitivity. For example, it may be difficult to isolate a person wearing a dark shirt standing against a dark background owing to the closeness between the color of the shirt and the background. This may cause the flood fill in paint mode to extend beyond the boundary of the shirt into the background, while jumping back from the background to the shirt when in delete mode. This may be avoided by manually increasing the sensitivity so as to require that the color difference between the seed pixel and the current pixel is smaller than the default value in order for the color to spread. This may be done, for example, using a scale or slider displayed on the screen and allowing the user to increase or decrease the flood fill sensitivity. The change includes among it the limit given to the flood fill function and other parameters.

Another option is to adjust the manner in which the painting process operates according to finger pressure. “Stretching” mode is invoked when the user momentarily applies intermittent finger pressure to effect fine adjustment of the mask at the edge. Stretching is designed for minor adjustments of the boundaries inside and outside the selected object. “Smearing” mode is invoked if the finger pressure lasts for more than a preset duration (e.g. 0.5 s), then a more massive painting occurs as a result of continued finger pressure, so that even if the picture has many colors the user can paint it relatively easy.

At the end of the painting process, the user can move to an additional screen where the object is placed in the center of the picture. For example, if the object has taken only 25% of the image an enlargement is made so that it can be placed in the center of the picture. At this stage the user can make another smoothing, so that the outlines of the painted area are smoothened. The user has the option to control that smoothing intensity according to the object he is trying to paint. Smoothing is suitable to an object that has a smooth edge, but not to an object with jaggy bumps, like tree branches or dog hair.

From the smoothing screen the user can decide to go back to the painting screen and mark/clear additional areas, or approve the painted area. After a final approval the user will get an overall picture of the selected object superimposed on a transparent background.

### Implementation

### General Principles

We first describe operation of the algorithm in general terms after which a detailed description will be presented with reference to the drawings.

Stage One—Preparation

At the preparation stage we allocate all the variables of the images that will be used in the algorithm. Since the image takes a lot of memory, the image is re-used if necessary and almost no memory is allocated while the program is running so that the memory management will not burden the program.

The size of the image is dependent on screen resolution which varies between different handset devices. Therefore, in some embodiments the size of the original image may be reduced to a nominal size (currently 320×320 pixels) for two reasons: first, at the end of the process, all the images are typically saved on a file server at the same size, and must be configured for easy transfer between users. Secondly, an image is a large object that is hard to process, and even a high resolution screen may not have high enough processing ability to process those images. Thus, if we allow every size of source images to arrive, it could make the algorithm run slowly or become stuck. It will, of course, be appreciated that processing power and memory capacity are being constantly improved and memory management of this kind may not be necessary.

Prior to painting the image is prepared by smoothing it, thereby removing salt and pepper noise i.e. tiny white or dark spots in the image which are the results of bad photographing quality like weak or unsatisfactory illumination. In addition, when flood fill is painted from a specific point, actually all the points around it will be weighted, such that the finger may be considered as covering an area and not just a point. Another possible image processing is comparing histograms and finding the boundaries using the Canny algorithm, which can be used later as an additional tool for delicate adjustments to the limits of the painted area. Another possibility is sharpening the image instead of smoothing it, to make the identification of the boundaries easier at the following painting stage. These processes are done on a copy of the image and do not affect the original image. In normal use of the algorithm, the sensitivity of the flood fill function is increased as the distance from the seed point increases so as to inhibit the flood fill from overreaching beyond the boundary.

Stage Two—Coloring

At any time that the user touches an image where there is no colored area or “mask” either because no area was previously selected or because a selected area was completely cleared, a coloring will always be made at the spot touched by the user.

Any other touch is processed as follows. If a double touch is detected, we always create a hole i.e. go into “clear state”. Otherwise we identify the pixel where the user touched and the adjacent pixels typically within a radius of ten pixels. This is necessary because the width of the user's finger is too coarse to identify a single pixel accurately, therefore calculating the surrounding area will always be the wiser step. If the expanded area contains at least a specified proportion of colored pixels e.g. 30%, it is assumed that the touch was inside the colored area and the user wants to expand it. Otherwise the touch is assumed not to be in the colored area and clear mode is initiated.

When the user initiates a touch, we always color/clear at the touched location according to the principles described above. But from here the user has three options: maintain finger pressure in that spot, move it without interrupting finger pressure or lift it so as to terminate finger pressure.

If the user lifts his finger, meaning that he ends the touch, we also end the coloring/erasing and wait for the user's next touch.

If the user maintains finger pressure, then if he is in a filling state and we continue to activate the flood fill function at fixed time increments with a higher spread parameter i.e. reduced sensitivity, so that more and more pixels will be colored as time goes by.

If the user moves his finger while maintain pressure, a line is created between the previous spot we colored/cleared and the new spot. We will describe this operation with regard to the filling state, although the process is similar for the clear state. Flood fill has already been activated at the place where the line begins so there is no point in activating the function again at the same spot. If we try to activate flood fill at every spot on the line, processing time will increase and we may not respond to the user's actions in time, or he may need to wait too long for his action to be finished. If we activate the flood fill directly at the new spot the user may have already moved his finger rapidly to a distant spot and we will create a discontinuity between the colored parts of the image despite the fact that the user did not lift his finger.

The solution is to “walk” along the line pixel by pixel and check each pixel: if it is colored, we move to the next one. Otherwise, the flood fill function is activated. If we have reached the last pixel, meaning the spot where the user is currently touching, we will activate the flood fill anyway. This preserves continuity. In addition, the user sometimes intentionally tracks a line that is entirely in the colored area that is close to the object's boundaries, in order to fix minor repairs on those boundaries and possibly extend the boundary. Therefore after ten consecutive pixels (or any other arbitrary number) are tracked, we activate the flood fill function even if all the tracked pixels are colored. By such means if the user moves his finger back and forth within the painted area but close to the boundary, flood fill will be activated thereby extending the boundary of the painted area.

Here we can introduce another optimization: when we have an item with a variety of details and colors, the flood fill function does not advance us much. Therefore we would like to activate the “smearing” even more. To do that we reach the first spot outside the “mask” as usual, calculate the circle as usual, but then we start activating the flood fill at a spot that is on the edge of the circle rather than in the circle. This way if any change of color will occur on the line, we will reach the color that is on the edge and try to activate the flood fill with that color, which may advance us faster across the line to the spot where the finger has reached.

After each coloring, we check if the user's finger still touches the device and if so, to where he moved it, if he did, and calculate a line again as needed.

We now discuss the technique of working with the flood fill function. First, besides the absolute difference between the reference pixel and the current pixel, which determines the extent of flood fill, we would also like to activate the function gradually, so that the more remote a pixel is from the central pixel, the higher will be the “penalty” imposed in the form of a lower color difference threshold between it and the central spot. This requires that the color difference between the two pixels must be less than a progressively lower threshold as we move from the seed point, thus making it harder to paint. In other words, the color difference threshold between pixels is automatically reduced as flood fill progresses further from the central pixel, so as to make the more remote area harder to fill. This way, the more remote the central pixel is from an object's boundaries, the smaller is the chance that the color will escape beyond the boundaries. In addition, the user cannot select a single pixel: his finger covers an area. Therefore, when coloring we also take a small circle around the central spot and progressively reduce the difference between it and the central spot to facilitate paint during the flood fill stage.

To this end, flood fill is not activated directly in the original image; rather we construct an image that contains the difference as an absolute value between all the spots in the original image and the central spot of the flood fill. Unlike many existing algorithms, we may until this stage work with all three color channels of the image rather than convert to grey scale. By subtracting from the absolute difference values the maximum of these three values, we determine which channel to use for the flood fill. Henceforth, instead of working on an image with three colors we work on an image with a single channel. However, conversion to grey scale is also possible.

Now that we have absolute values, these can be added to a predetermined distance matrix and we can lower the values in the circle nearest to the central spot, thereby making this circle easier to color. This is used to aggressively color the circle i.e. to forcibly color a small area surrounding a seed point.

All that is left is to activate flood fill and update the “mask” according to it. After activating flood fill, if we colored we check for any uncolored area or “hole” within the colored boundary. Any such “holes” are filled. If we cleared, we check if we enlarged an existing hole that was created with double click in the previous stage and update our images that keeps the state of the holes. If we colored, we also check if an existing hole was partially colored, thereby leaving tiny holes. If so, they also are filled so as to obviate the need for the user to track these tiny holes and fill them himself. The size of the holes that are too small to leave inside the image is preset.

It should also be noted that while clearing the mask we check that the continuity of the mask is not destroyed, meaning that the user did not erase a line in the middle of the mask thereby splitting the mask into two or more separate colored areas. If this did happen, we leave only the portion that includes the first spot the user had touched when he created the colored area in that image, and clear the remaining portions. If the first spot the user had touched was erased as a result of removing the separating line, we do not clear the whole mask but rather find a new anchor spot. This is done by finding the colored spot that is the farthest from any uncolored area. Informally, we find the center of the colored portion that is the thickest and make it our new anchor spot. Now the portion containing this spot remains colored and all other portions that are not attached to it are successively cleared.

It should however be noted that the invention does allow for creation of two or more masks each marking a different object in the displayed image. A possible implementation of this is described below.

### Practical Embodiment

Having described the basic principles, a practical embodiment will now be described with reference to the drawings.

Overall Schematic:

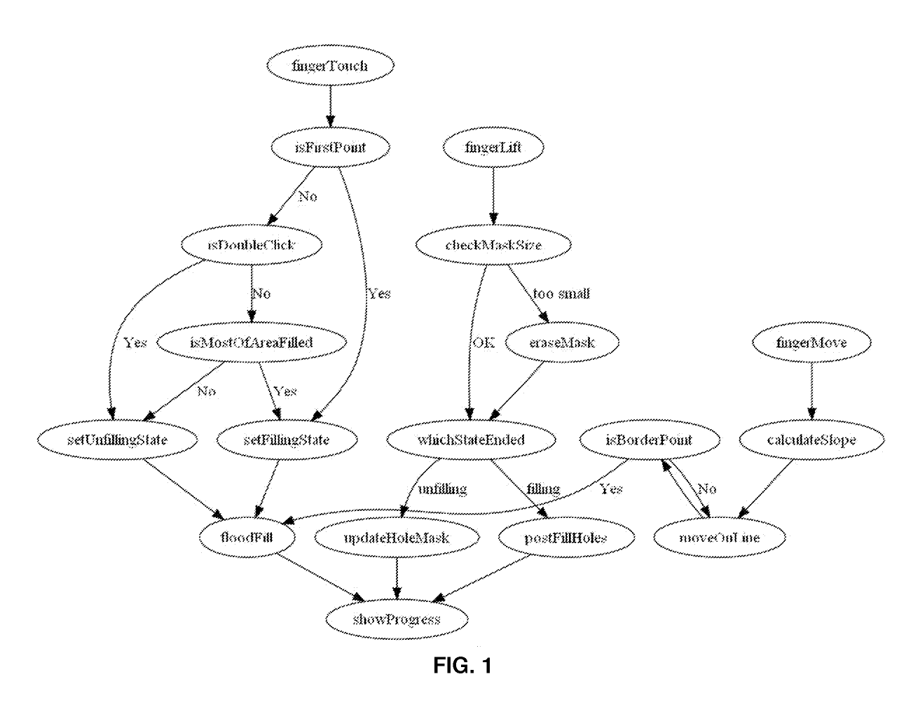

FIG. 1 is a state diagram each of whose ellipses denotes a user action that has been described above and the consequences of which are now described in more detail.

fingerTouch—the user started pressing the device. The central spot under the user's finger is saved as —firstTouch and as seedPoint together with a time stamp denoted as pressDownTime indicating the time of contact.

isFirstPoint—checks if this is the first touch. Actually it may not necessarily be a first touch since the user may have created a mask before but cleared it completely, so that there is no saved mask at the moment. In this case, we always move to a filling state since there is nothing to clear and there is no mask to create a hole therein. In addition we save the spot as startPoint, i.e. a variable which holds the value of the current reference pixel.

isDoubleClick—checks if a double click was made. This is done by comparing the time that elapses between this press and the previous one i.e. the difference between preivousPress and pressDownTime. If the elapsed time is shorter than a preset threshold (currently defined as 0.2 s), the current press is construed as a double click. If a double click were made, we move to clear state because the user is about to create a hole in the mask. In addition, we update the floodFill variables aggressively coloring width, floodDiff to be the variables for creating a hole.

isMostOfAreaFilled—checks if most of the area around the spot is colored. Here we check if the user had pressed a colored area and wants to extend it, or he pressed an uncolored area and he wants to clear the mask. We check not only the spot returned by the smartphone/tablet device since it may seem to the user that he pressed a colored area where in fact the middle pixel in his pressing area is not colored. Therefore we check what fraction is colored in a small area around the spot: if at least a preset percentage, for example 20% or 30%, of the area is colored we treat the spot as if it is colored and move to the filling state; otherwise we move to clear state.

setFillingState/setUnfillingState—marking the flag according to the state we moved into.

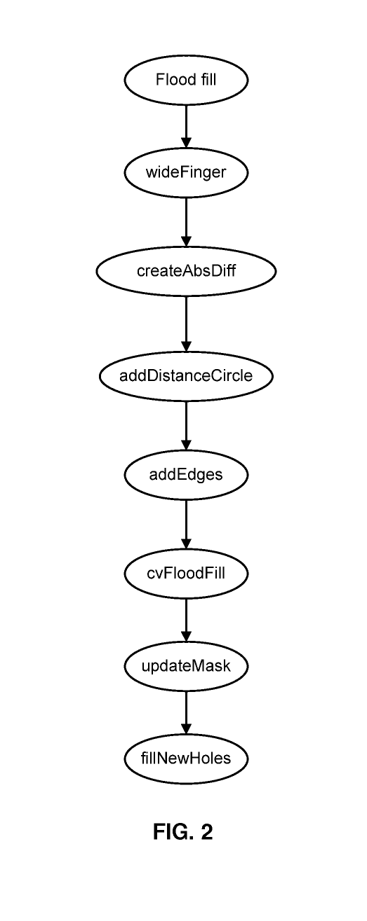

floodFill—calls the flood fill function, as shown in FIG. 2. Generally the flood fill function adds all the squares around the spot that their color is close to the color of the spot to the colored part.

showProgress—calls the showProgress function, showing the current state of the image and its mask to the user. This function preserves continuity of the mask. If the mask is discontinuous because an intermediate area of the mask was cleared, it leaves only the portion including the startPoint. If the portion of the mask that included the startPoint were previously erased, we calculate the central point of the current mask as central of gravity and declare this point as the new startPoint. If this point resides within a marked area we then erase the other portions of the mask. If not we leave the largest one, erasing all others.

fingerMove—a flag indicating that the user's finger already touches the device and he moved it. The new spot is saved as seedPoint.

calculateSlope—calculates the gradient of the virtual line between the last point where the flood fill was made and the existing point. This is done by calculating the difference between the respective x and y coordinates.

moveOnLine—moving across the line. We move to the next point on the line: if the gradient is smaller than 1, we move one pixel along the x axis and update y according to the slope. Otherwise we do the same in reverse. This way we are assured to move to the next level in a continuous way.

isBorderPoint—checks if the point is inside the boundary of the mask or if we have reached the end of the line. If we are in a filling state, then our previous point is colored and we move across the line until we find the first uncolored point. If we are in the clear state, we symmetrically move across the line in both directions until we find the first colored point. In addition, if we have reached the end of the line i.e. the point where the user is currently pressing, or if we have moved over a certain number of points e.g. 10 points, we stop anyway even if it is not a boundary point.

floodFill—activates the flood fill function, as described above.

fingerLift—the user lifted his finger meaning he ended the clear/coloring action.

checkMaskSize—checks the size of the mask. We check the size of the mask after the coloring. If the mask is too small, for example a single pixel in width, it will barely be seen, if at all, by the human eye and hard to clear in case the user meant to clear a mask and start all over again. In this case, the mask is deleted.

eraseMask—erases and resets the existing mask. In addition, we clear the startPoint so that the user's next touch will put the algorithm into a filling state and will be considered as if it is the first touch.

whichStateEnded—checks what the user did in the touch that just ended for the sake of the cleanup: i.e. either filling or clearing. Based on this, we either fill residual holes or clear residual spots of isolated marked areas. Updating the mask to display new holes can be done only after a clear is done.

postFillHoles—fills holes. If the user had filled in a way that left an uncolored closed area inside the mask, we fill it. Existing holes that were made by clearing an internal portion of the mask are not automatically filled, since any such holes were created intentionally by the user. Holes that are the residue of the user having almost completely filled a portion of the mask leaving a small number of pixels unfilled are assumed to have been left in error and are filled automatically.

updateHoleMask—updates new holes in the mask. We check if the user created/enlarged new holes in the clear process and update the mask accordingly.

Flood Fill

FIG. 2 is a flow diagram depicting flood fill, which is now described in more detail.

floodFill—a call was made for the flood fill function.

wideFinger—the user's finger is to be considered large. Since the user does not identify the specific pixel that is on the area that he presses, unlike using a computer mouse for example, we assume that the area where his finger is pressed might give us extra information and we analyze this area at this stage. Actually, we look at a small square around the spot and not just the actual spot and then we normalize its data.

calculateAbsDiff—calculate the difference matrix. We create a matrix equal in size to the original image, containing the differences in absolute values of the color levels between every pixel in the square and the seed point. The matrix includes for each pixel in the original image a corresponding current state such that the larger the color difference between the point in the original image and the seed point, the higher is the corresponding current state. If the current state of a pixel is zero, this means that the color of the corresponding pixel is identical to that of the seed point. Staying with the original image would have yielded higher color values for some portions, and a smaller color value at others and would have made it harder to perform the next steps. After obtaining the absolute values we create a matrix that is the maximum between the values in the three channels, because only the maximum will interest us in the next stages.

addDistanceCircle—add the distance matrix to the absolute difference matrix. We add to the matrix from the previous stage the distance matrix that was made in advance, so that the farther a point is from the seed point, the higher the value it is assigned. Now, the value assigned to each point in the matrix is a calculation of its distance from the seed point and the color difference between the respective image pixel and the image pixel corresponding to the seed point. In addition at this stage we reduce the sensitivity in a small circle that is close to the seed point to make the coloring in that circle easier.

addEdges—add edges to the absolute values matrix. In case we are interested, we will add here the boundaries that were calculated earlier with the Canny algorithm or with another algorithm to make them stronger, to make it more difficult for the flood fill function to go through them. This action also has a disadvantage because it makes it harder for the user to color and cross boundaries if he desires to.

cvFloodFill—perform flood fill in the absolute values matrix. The parameters are assigned according to the state we are in (coloring, erasing, drilling a hole).

updateMask—update the mask. If we performed a filling, the mask's colored area is updated by the surface we colored with the flood fill. If we cleared the mask's uncolored area is updated by the surface we colored with the flood fill.

fillNewHoles—fill residual holes created during the coloring process.

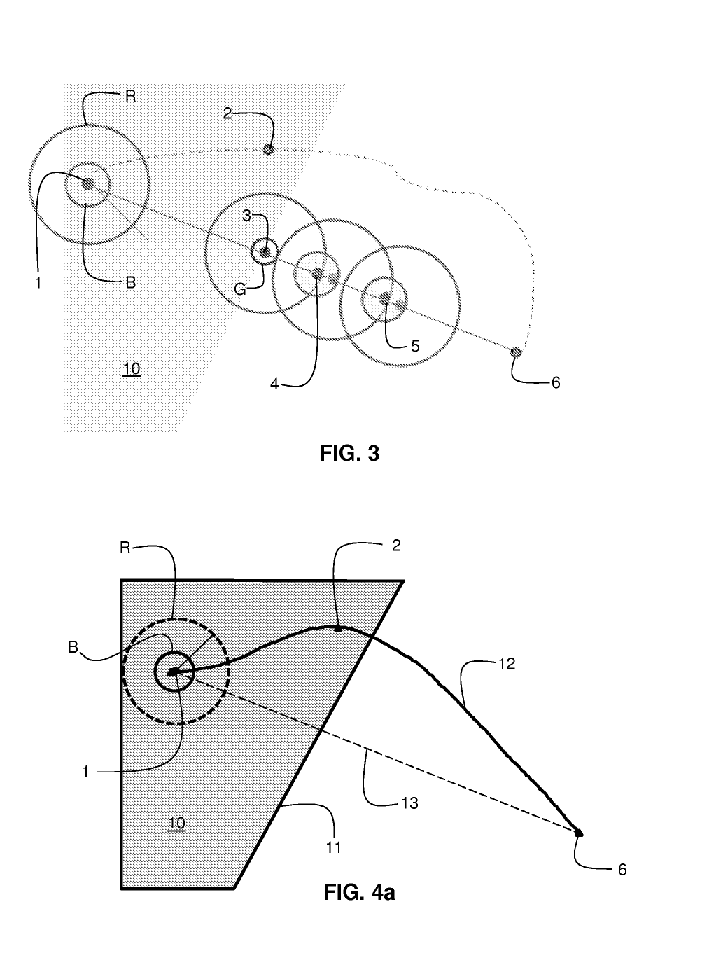

FIG. 3 shows pictorially the effect of touching the image where the shaded portion is a mask, i.e. a portion of the image that is already colored before the user's touch was made.

The first touch of the user is at the point marked as 1. Since it is a first touch a filling will always be made. First we aggressively color the point within the circle marked B. Then flood fill is executed until the boundaries of the circle marked R, according to the image's colors. In any event, there is no difference in this case because the entire area is already colored.

The second touch on the Smartphone/tablet device is at the point marked as 2. We move across the line between point 1 and point 2 and since all the points in this line are colored we ignore the touch.

The third touch on the Smartphone/tablet device is at the point marked as 6, where it is assumed the user lifts his finger from the touchscreen. Now we calculate a line from the last point we performed the flood fill (point 1 in this case) and perform a stretching filling in the first point outside the mask. To this end the radius of the circle G that is aggressively colored is smaller than that of subsequent circles.

If more than a preset time interval has passed e.g. 0.8 seconds since the user last lifted his finger from the touchscreen, we relate to the current placement as the first placement, for which we always implement stretch mode, whereby only the center pixel serves as the seed pixel for the flood fill function. This ensures that for the newly defined seed pixel we color cautiously rather than aggressively. We continue across the line until we reach the next unmasked point after the filling that was spawned by point 3, namely point 4. The small circle around this point corresponding to the finger area is filled aggressively and the point on the line which intersects its circumference outside the current boundary of the mask serves as the new seed point where flood fill is executed. We will refer to this point on the circumference as the ‘farthest reach’ of the circle. If no new seed point is selected by the user, the same process is then repeated iteratively until we reach the end of the line i.e. point 6.

However, if after filling point 5 the user touches the smart screen at a new seed point, we draw the next line to this new seed point at the point where flood fill last terminated and not from point 6.

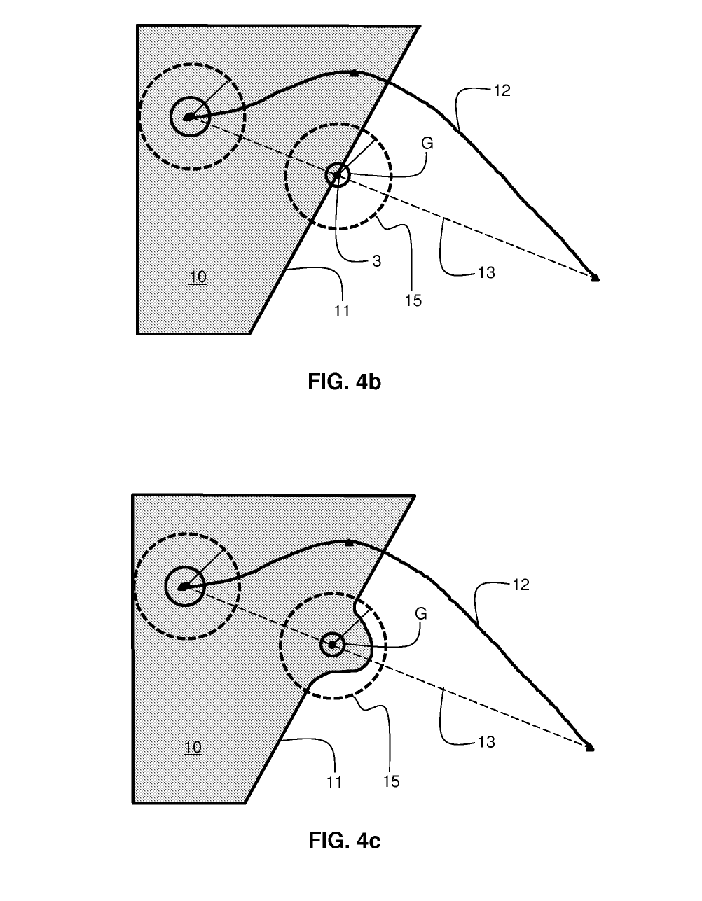

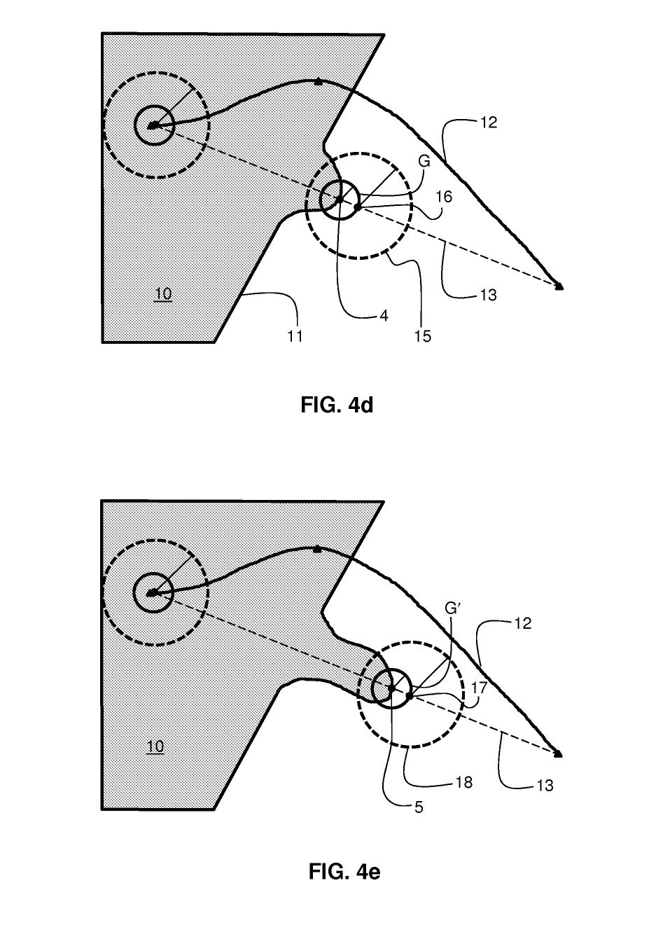

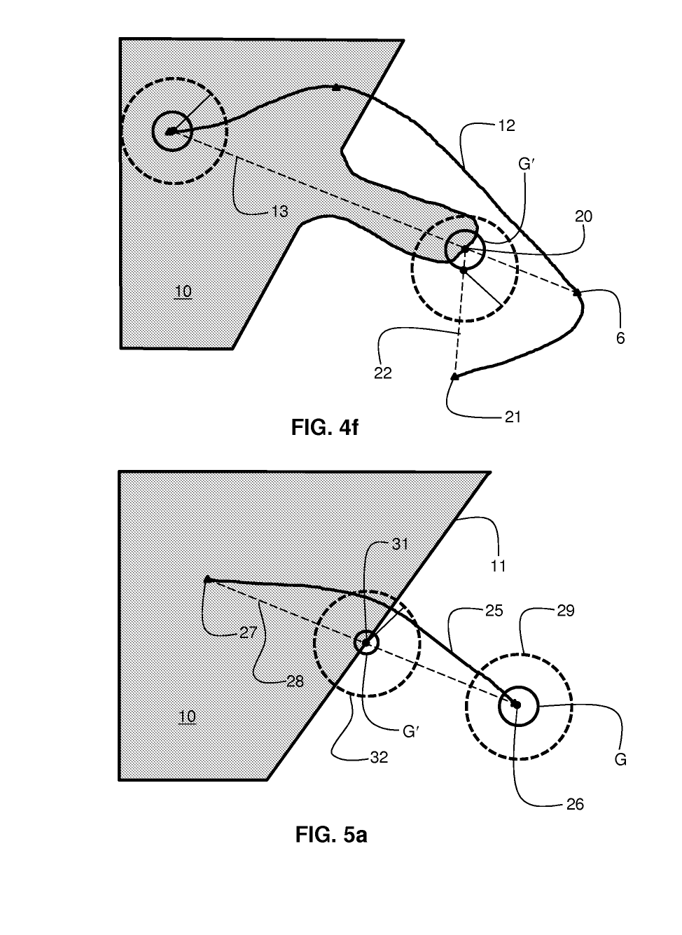

FIGS. 4a to 4f are pictorial representations of the mask layer during successive iterations of the algorithm when constructing the mask. Thus, FIG. 4a shows an existing mask 10 that has a boundary 11 and contains an initial seed point 1 from which a user traces a continuous line 12. Thus, the line 12 extends from with the current mask 10 to an area remote therefrom and not yet covered thereby. The algorithm samples points on the line at a predetermined sampling rate. These points, depicted by triangles, include, of course, the seed point 1, which is sampled as soon as finger pressure on the input device is detected, as well as points 2 and 6 (using the same numbering as FIG. 3). As noted the initial seed point 1 represents the nominal center of contact around which there is constructed a circle B that is aggressively painted using flood fill. The initial seed point 1 likewise serves to propagate a circle R of larger radius than that of the circle B. The algorithm constructs an imaginary line 13 that directly connects between the initial seed point 1 and the last point 6 touched by the user before lifting his finger from the input device. The number of points on the line that are sampled is indeterminate since typically only limited processing and memory resources are dedicated to propagating the boundary of the mask. As the mask propagates, new points will be sampled for so long as the line between the start and end points is current. But before the algorithm samples additional points on the line, the user may initiate a new stroke thus defining a new line causing the algorithm to jump from its current pixel location to the start point of the new line.

We now describe how the algorithm operates iteratively to extend the boundary of the mask 10. The algorithm moves point by point along the line 13 until it reaches the boundary 11 of the mask as shown in FIG. 4b. Where the line 13 crosses the boundary 11, this defines the next seed point 3 around which there is constructed a small circle G that is aggressively painted using flood fill and which propagates the mask outward within a larger circle 15 also centered on the seed point 3. The result of this propagation is shown in FIG. 4c where it is seen that the boundary 11 of the mask 10 intersects the line 13 at point 4 as shown in FIG. 4d. However, it is seen in FIG. 4d that for this and subsequent seed points, we do not use the center 4 from which to propagate the mask since the center already lies on the mask's current boundary 11. Instead, we construct the small circle G around this point and determine the point 16 where the farthest reach of the small circle G intersects the line 13 and use this as the next seed point to propagate the mask 10 as shown in FIG. 4e.

The same process is repeated iteratively. Thus, as shown in FIG. 4e the point 5 where the boundary of the mask intersects the line 13 serves as the center for the small circle G′. The point 17 where the farthest reach of the circle G′ intersects the line 13 is used as the next seed point to propagate the mask 10 as shown in FIG. 4f. It will be noted that radius of the circle G′ is larger than that of the circle G shown in FIGS. 4b and 4c. The reason for this is that the circle G is centered on the initial boundary of the mask when the user first starts to drawn the line 12. At this instant, the algorithm has no way to know whether the user is making only intermittent contact indicative of stretch mode or is making continuous contact indicative of paint mode. The algorithm can only know this at subsequent iterations if, after the preset time period, finger pressure on the touchscreen is still detected. Since initial contact could be indicative of stretch mode, the radius of the circle G is only a few pixels so as to allow fine adjustment near the boundary.

FIG. 4f shows yet a further refinement. It is seen that with the boundary of the mask 10 at point 20, the user has moved his finger (or other input device) to a new point 21. In other words, the end point has now moved to a new position before the mask has propagated to the original end point 6. In this case, the algorithm no longer iterates relative to the original line 13 but creates a new line 22. The small circle G′ is now constructed centered on the point 20 where the boundary intersects the line 22. This circle is aggressively filled and its farthest reach intersects the line 22 defines a new seed point that allows propagation of the mask along the new line 22.

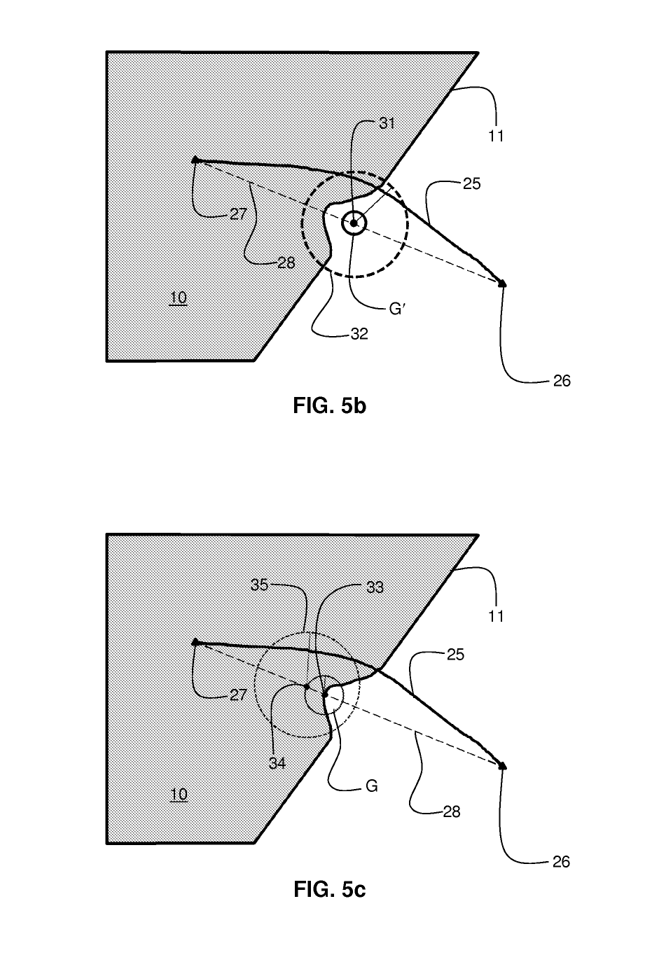

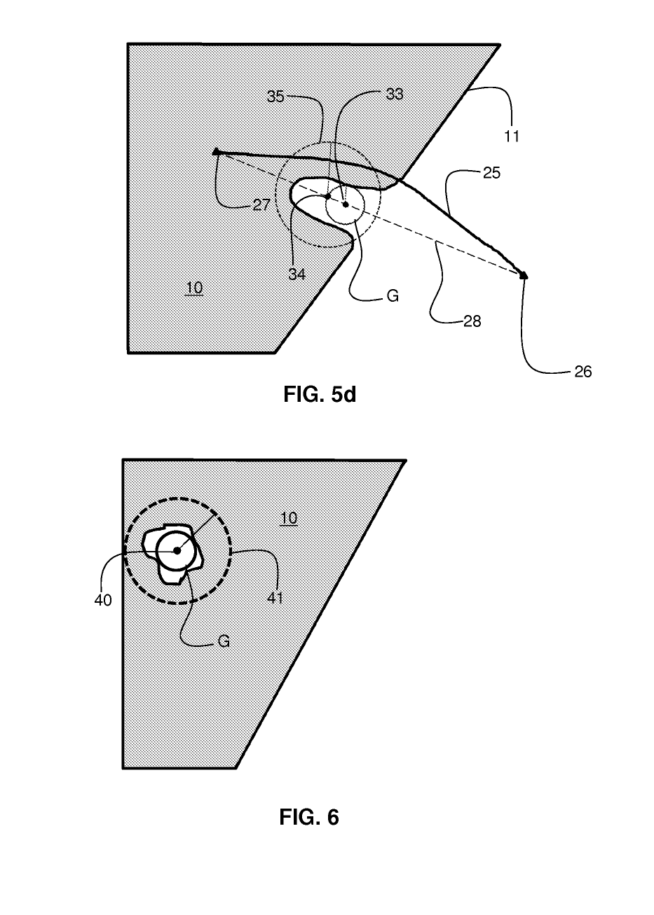

FIGS. 5a to 5d are pictorial representations of the mask layer during successive iterations of the algorithm when erasing parts of the mask. It is assumed for the sake of explanation that the user moves his finger along touchscreen thus describing a line 25 that extends from a first point 26 outside of the mask to an end point 27 inside the mask. The initial point defines also a corresponding reference pixel in the image whose color attribute serves as a reference. The algorithm constructs an imaginary straight line 28 between the first point 26 and the end point 27. For the initial point the algorithm may be designed to construct a first small circle G centered on the point 26, which is aggressively cleared and around which there is centered a second circle 29 of larger radius which serves to propagate along the straight line 28 toward the end point 27 and renders all points of the mask within the circle transparent for which the color attribute of the corresponding image pixels differs from that of the reference pixel by less than a preset threshold. The construction of this is an optional implementation and has meaning only if the first point 26 is closed to the initial boundary of the mask. When implemented, it may be assumed that the user will press on the touchscreen with his finger clear of the mask such that there is little risk of the circle G crossing the boundary. So it may be of larger radius than corresponding small circles drawn in subsequent iterations.

FIG. 5a also shows the first iteration where the algorithm progresses along the line 28 one pixel at a time until it reaches the boundary 11 of the mask. Where the boundary 11 crosses the line 28 defines the first seed point 31 about which a circle G′ of somewhat smaller radius than the circle G is drawn in which all points are aggressively cleared, i.e. rendered transparent. The radius of the circle G′ is only a few pixels because the algorithm does not yet have any way to know whether the erasing is being done intermittently in stretch mode or in continuous clear mode. A circle 32 of larger radius is constructed centered around the first seed point 31 and serves to propagate the flood fill in an analogous manner to the mask propagation described above, except that in this case flood fill is used to clear all those points in the mask for which the color of the corresponding pixels in the image differ from that of the reference pixel by less than a preset threshold.

FIG. 5b shows the result of the first iteration where some of the mask within the circle 32 is rendered transparent thus pushing back the boundary of the mask.

FIG. 5c shows a subsequent iteration where the point 33 where the boundary of the mask crosses the line 28 defines the center of a circle G of small radius (but larger than the circle G′) which is aggressively cleared. Where the farthest reach of the circle G intersects the line 28 defines a new seed point 34 around which there is centered a large circle 35 which serves to propagate along the line 25 toward the end point 27 and renders all points of the mask within this circle transparent for which the color attribute of the corresponding image pixels differs from that of the reference pixel by less than a preset threshold. The result of this operation is shown in FIG. 5d.

FIG. 6 is a pictorial representation of the mask layer when creating holes. In this case, on detecting a double click on the touchscreen within a preset small time period, a center point 40 is defined as the first detected pixel and all points with a small circle G centered on the center point 40 are cleared. A larger circle 41 is constructed centered on the center point 40. The image pixel corresponding to the center point 40 serves as a reference pixel whose color attribute is determined. For so long as finger pressure is maintained, additional points within the circle 41 are cleared so as to push back the boundary of the mask where the color attribute of the corresponding pixel differs from that of the reference pixel by less than a predetermined threshold.

It will, of course, be appreciated that an intention on the part of the user to create of holes may be indicated by means other than double clicking. For example, continued pressure applied to the touchscreen or tablet or a continuous click of the mouse for more than a specified duration might equally well be used to distinguish the need to create a hole in the mask from the need to expand the mask.

### Second Embodiment

In another use of the algorithm, the colored mask is not shown on the screen. Instead, portions of the image where there should be a mask are rendered visible, and portions for which there is no mask are rendered transparent, revealing what is behind it. This may be used to create a composition of two images, when the uppermost image contains an object that the user wishes to insert into the lower image which lies behind it. The process starts when the invisible mask fully covers the uppermost image such that the uppermost image is completely visible and conceals the lower image. When the user starts to clear the invisible mask surrounding the desired object in the upper image, those areas become transparent, revealing the lower image behind it. By the end of this process the desired object from the uppermost image is shown on the background of the lower image.

The same way that the user interacts with the colored mask by pushing forward its edges to mark more area or swiping it back to clear, is done with the visible portion of the image. The user can either push the edges of the visible area forward to expose more area of the object, or swipe the edges of the visible area back from the outside to clear and turn it transparent.

There are two options to start the process. One is to start with the entire top image initially covered by the invisible mask, as in the example described above, such that the top image is initially visible. The other option is to start the process when there is no mask and the top image is fully transparent, such that only the lower image behind it is shown. When the user touches the screen and initiates the mask, the area where the mask is created becomes visible, revealing the object of the top image over the background of the bottom image.

If desired, the transparent areas of the top image may be rendered only partially transparent during the marking process, so that the user can get some sense what lies in the transparent area without the need to reveal it.

It should also be noted that the operating systems of smartphones have zoom and pinch functions operated by two fingers in known manner. The algorithm reacts to zoom by automatically reducing the difference threshold between the color of the current pixel and that of the seed pixel, so that the flood fill spreads more slowly i.e. its sensitivity decreases. Likewise, the sensitivity during clear mode may be increased relative to that in paint mode.

### Alternative Embodiments

Although the invention has been described with particular reference to a smartphone having a touchscreen where the mask is constructed in real time in response to the user describing a continuous line on the touchscreen with his or finger, it is to be understood that this is only by way of example. Thus, the principles of the invention are also applicable where the line is described using a pen or stylus on a touchscreen or tablet. In case of a tablet, the display and the input device are clearly separate components. The invention contemplates use of either, since all that is required is that the algorithm be able to map points in the mask to pixels in the displayed image. Likewise, a regular PC can be used where the image is displayed on a computer display screen and is tracked using a computer mouse or similar device. In such case, the mouse, for example, is the input device and is used to track the image by virtue of its movement on a surface that is not itself part of the system. This is different from those embodiments where the input device is a tablet or smartphone that tracks movement of the user's finger or stylus: but in all cases it is the input device that feeds the tracked coordinates to the processor for further processing.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

### Possible Uses of the Invention

The invention is directed to the actual marking of an object in a displayed image so as to extract an identifiable portion of image within defined and clear visible boundaries. The invention is not specifically directed to what is then done with the marked object. Typically, the object thus identified by the invention is post-processed. This may include:

a. Editing the object and its background differently;

b. Extracting the object from the image to display it without the original background;

c. Any other image processing that requires first isolating the object from the remainder of the image.

1. A machine-implemented method for use in an apparatus comprising at least a processor, a memory, a display configured for displaying an image and an input device, said method comprising:
highlighting an object in the image that is at least partially marked by a mask;
receiving in real time respective inputs indicating successive selection points located on a line that crosses the mask and is representative of a path described by a user using continuous movements by or on the input device and each corresponding to a respective reference pixel in said image;
determining an initial reference point where said line crosses a boundary of the mask;
determining an attribute of a reference pixel in the image corresponding to the initial reference point;
using the initial reference point as a seed point to successively change an attribute of successive points in the mask centered on the seed point for all points in the mask corresponding to pixels in the image surrounding the respective reference pixel and for each of which points the corresponding pixel attribute in the image differs from the pixel attribute of the corresponding reference pixel in the image by no more than a predetermined first threshold;
measuring an elapsed time between initiation and termination of continuous uninterrupted drawing of the line;
if the elapsed time is less than a predetermined threshold;
setting a display attribute of all points within a circle of a predetermined first radius centered on the initial reference point to a predetermined value;
using only the initial reference point as a seed point for changing the attribute of successive points in the mask for all remaining points within a circle of a predetermined second radius that is larger than the first radius and is centered on the initial reference point and for which the pixel attribute of the corresponding pixel in the image does not differ from the attribute of the reference pixel by an amount exceeding the first threshold.

2. The method according to claim 1, wherein:
the path described by a user starts from inside the mask and extends to outside the mask; and
the attribute of each point in the mask is changed so as to fill a portion the mask containing said points with a predetermined color.

3. The method according to claim 1, wherein:
the path described by a user starts from outside the mask and extends to inside the mask; and
the attribute of each point in the mask is changed so as to clear a portion the mask containing said points.

4. The method according to claim 1, including:
iteratively constructing the mask in real time so as to contain successive points each centered on successive seed points on said line where the line crosses the mask at a respective iteration, each of the seed points corresponding to a respective reference pixel in the image, each of the points in the mask corresponding to pixels in said image surrounding the respective reference pixel for the respective iteration and for each of which points the corresponding pixel attribute in the image differs from the pixel attribute of the corresponding reference pixel in the image by no more than a predetermined first threshold; and
iteratively using the mask to mark an object in the displayed image in real time; and
repeating for successive paths described by the user.

5. The method according to claim 4, wherein using the mask includes at least displaying the mask and at least partially concealing all pixels of the image that overlap the mask.

6. The method according to claim 4, wherein using the mask includes displaying only those pixels of the image that overlap the mask.

7. The method according to claim 4, including clearing portions of the mask by:
receiving in real time respective inputs indicating successive selection points located on a line that is representative of a path described from outside the mask to inside the mask by a user using continuous movement by or on the input device and each corresponding to a respective reference pixel in said image; and
iteratively clearing points from the mask for which the corresponding pixel attribute in the image differs from the pixel attribute of the corresponding reference pixel in the image by no more than a predetermined second threshold.

8. The method according to claim 7, wherein the second threshold is different to the first threshold so as to provide different sensitivities when deleting and painting.

9. The method according to claim 8, wherein the second threshold is less than the first threshold so as to reduce the rate at which points are deleted from the mask.

10. The method according to claim 4, wherein the input device is a touch-sensitive input device.

11. The method according to claim 10, wherein the touch-sensitive input device is a touch screen that also serves as the display.

12. The method according to claim 11, wherein the input is obtained as a result of finger contact with the touch-sensitive input device.

13. The method according to claim 10, wherein the touch-sensitive input device is a tablet.

14. The method according to claim 13, wherein the input is obtained using a stylus or pen.

15. The method according to claim 1, wherein the display is a computer display screen and the input device is a mouse.

16. The method according to claim 1, wherein the predetermined threshold associated with a point in the mask changes according to its distance from the selection point.

17. The method according to claim 4, wherein iteratively constructing the mask includes:
measuring an elapsed time between initiation and termination of continuous uninterrupted drawing of the line;
if the elapsed time is not less than a predetermined threshold:
setting a display attribute of all points within a circle of a predetermined first radius centered on the initial reference point to a predetermined value;
for all remaining points within a circle of a predetermined second radius that is larger than the first radius and is centered on the initial reference point and for which the pixel attribute of the corresponding pixel in the image does not differ from the attribute of the reference pixel by an amount exceeding the first threshold, setting the display attribute of said point to said predetermined value;
selecting successive seed points along the line at a predetermined sampling frequency while the line is being drawn;
for each of said seed points whose display attribute is not equal to said predetermined value:
setting the display attribute of all points within a circle of said predetermined first radius centered on the seed point to said predetermined value;
determining an intersection point where a circumference of said circle at its farthest reach intersects the line; and
for all remaining points within a circle of said predetermined second radius centered on said intersection point and for which the pixel attribute of the corresponding pixel in the image does not differ from the attribute of the reference pixel by an amount exceeding the first threshold, setting the display attribute of said point to said predetermined value.

18. (canceled)

19. The method according to claim 1 including updating the line in real time so as to continually track the path described by the user.

20. The method according to claim 1 including:
identifying a reference point located inside the mask responsive to a user input indicative of a desire by the user to clear an interior portion of the mask;
determining an attribute of a reference pixel in the image corresponding to the reference point; and
using the reference point as a seed point to clear successive points in the mask centered on the seed point for all points in the mask corresponding to pixels in the image surrounding the respective reference pixel and for each of which points the corresponding pixel attribute in the image differs from the pixel attribute of the corresponding reference pixel in the image by no more than a predetermined first threshold.

21. The method according to claim 20, wherein a measured duration of said user input or a measured elapsed time between successive user inputs is used to indicate the desire by the user to clear an interior portion of the mask.

22. The method according to claim 1 including:
identifying a reference point located outside the mask responsive to a user input indicative of a desire by the user to construct a new mask; and
iteratively constructing the new mask around said reference point.

23. The method according to claim 1, including displaying a threshold selector for allowing user adjustment of the thresholds.

24. A computer program product storing computer program code configured to execute the method according to claim 1 when run on a computer.
